(19) United States
(12) Patent Application Publication
(10) Pub. No.: US 2010/0287384 A1
(43) Pub. Date: Nov. 11, 2010

(54) ARRANGEMENT FOR AND METHOD OF PROTECTING A DATA PROCESSING DEVICE AGAINST AN ATTACK OR ANALYSIS

(75) Inventor: Gerardus Tarcisius Maria Hubert, Aachen (DE)

Correspondence Address: SCHWEGMAN, LUNDBERG & WOESSNER, P.A., P.O. BOX 2938, MINNEAPOLIS, MN, 55402, US

(73) Assignee: KONINKLIJKE PHILIPS ELECTRONICS, N.V., EINDHOVEN (NL)

(21) Appl. No.: 11/993,289

(22) PCT Filed: Jun. 23, 2006
(86) PCT No.: PCT/IB06/52053

§ 371 Date: Jul. 27, 2010

(30) Foreign Application Priority Data
Jun. 29, 2005 (EP) 05105803.0

(51) Int. Cl. G06F 21/00

(52) U.S. Cl. 713/190

(57) ABSTRACT

In order to further develop an arrangement for as well as a method of protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations wherein an attack, for example an E[lectro]M[agnetic] radiation attack, or an analysis, for example a D[ifferential]P[ower]A[nalysis], such attack or such analysis in particular targeted on finding out a private key, is to be securely averted, it is proposed to blind all intermediate results of the calculations by at least one random variable.

The present invention relates in general to the technical field of impeding crypto analysis, in particular of protecting at least one data processing device against at least one attack, for example against at least one E[lectro]M[agnetic] radiation attack, or against at least one analysis, for example against at least one D[ifferential]P[ower]A[nalysis].

More specifically, the present invention relates to an arrangement for and a method of protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations.

Data processing devices, in particular embedded systems, such as chip cards or smart cards, use P[ublic]K[ey]I[nfrastructure] systems for exchanging keys and have to be protected against several forms of attacks targeted on finding out the private key. One such attack is to influence the calculation, in particular the cryptographic operation, by directing
one or more light sources on the chip, in particular on the naked (and thus light-sensitive) chip or
some kind of E[lectro]M[agnetic] radiation source(s) on the chip.

For calculations based on the R[ivest-]S[hamir-]A[dleman] algorithm and/or on the E[lliptic]C[urve]C[ryptography] algorithm, a lot of multiplications are required. Normally, these calculations are performed without protection against side-channel attacks, as for instance current trace analysis.

This might be vulnerable to a D[ifferential]P[ower]A[nalysis] attack because an attacker might take a lot of current traces each time the same multiplication is performed. After adding these traces, most of the noise is removed. When the attacker does the same but for different inputs, the attacker can compare the current traces and learn the secret key bitwise, i.e. bit for bit.

Prior art document WO 01/97009 A1 discloses a method for cryptographic calculation comprising a modular exponentiation routine. This known method works with two random variables to blind intermediate results; in this context, prior art document WO 01/97009 A1 works also with an addition of a random variable but only the multiplication operation is blinded.

However, before the result is used for the next calculation, this result is first unblinded which makes the result again vulnerable; not only the multiplication is sensitive to D[ifferential]P[ower]A[nalysis] but also the access of the R[andom]A[ccess]M[emory] of the unblinded results.

Prior art article “On Boolean and Arithmetic Masking against Differential Power Analysis” by Jean-Sébastien Coron and Louis Goubin discusses the D[ifferential]P[ower]A[nalysis] attack and suggests in the fourth and fifth paragraph of page 2 to mask all inputs and outputs. The fifth paragraph discusses masking of R[ivest-]S[hamir-]A[dleman] by multiplication, wherein reference is made to Thomas S. Messerges, “Securing the AES Finalists Against Power Analysis Attacks”, FSE 2000, Springer-Verlag.

Prior art thesis “Modeling and applications of current dynamics in a complex processor core” by Radu Muresan mentions on pages 33 to 37 the blinding of the point on the elliptic curve before applying E[lliptic]C[urve]C[ryptography].

Regarding the technical background of the present invention, additional reference can be made to
prior art article “Energy-Efficient Data Scrambling on Memory-Processor Interfaces” by Luca Benini, Angelo Galati, Alberto Macii, Enrico Macii, and Massimo Poncino;
prior art article “A Study of Power Analysis and the Advanced Encryption Standard—Recommendations for Designing Power Analysis Resistant Devices” by Tom Lash;
prior art document EP 1 267 514 A9;
prior art document GB 2 345 229 A;
prior art document US 2003/0194086 A1;
prior art document WO 00/42511 A1;
prior art document WO 01/08012 A1;
prior art document WO 02/50658 A1;
prior art document WO 03/101039 A1; and
prior art thesis “An Investigation of Differential Power Analysis Attacks on FPGA-based Encryption Systems” by Larry T. McDaniel III.

Starting from the disadvantages and shortcomings as described above and taking the prior art as discussed into account, an object of the present invention is to further develop an arrangement as described in the technical field as well as a method of the kind as described in the technical field in order to be capable of securely averting an attack, for example an E[lectro]M[agnetic] radiation attack, or an analysis, for example a D[ifferential]P[ower]A[nalysis], such attack or such analysis in particular targeted on finding out a private key.

The object of the present invention is achieved by an arrangement comprising the features of claim 1 as well as by a method comprising the features of claim 7. Advantageous embodiments and expedient improvements of the present invention are disclosed in the respective dependent claims.

The present invention is principally based on the idea to use an arrangement for as well as a method of blinding intermediate results for providing invulnerability, in particular D[ifferential]P[ower]A[nalysis] invulnerability; in particular, such blinding is employed in multiplications comprised by the calculations, in particular by the cryptographic operations, by employing at least one random variable.

More specifically, a message M can be blinded with a variable V. This variable V can be derived from a randomly chosen variable v. In this way, all intermediate results are also blinded; these intermediate results remain blinded until the end of the calculations, in particular until the end of the cryptographic operations.

According to an expedient embodiment of the present invention, all intermediate results are blinded by a random variable which is kept constant during a complete R[ivest-]S[hamir-]A[dleman] calculation or a complete E[lliptic]C[urve]C[ryptography] calculation but which is changed when a new calculation is started. By this, all current traces are changed, even when all inputs are the same because the random variable is not the same.

In a preferred embodiment of the present invention, the principle of Montgomery reduction is used. The Montgomery reduction is an efficient algorithm for multiplication in modular arithmetic introduced in 1985 by Peter L. Montgomery. More concretely, the Montgomery reduction is a method for computing c=a b mod(n) where a, b, and n are k-bit binary numbers.

The Montgomery reduction is now applied particularly in cryptography. Let m be a positive integer, and let R and T be integers such that R>m, g[reatest]c[ommon]d[ivisor](m,R)=1, and 0≦T<m·R. To calculate TR⁻¹ mod(m) without using classical method is called the Montgomery reduction of T modulo m with respect to R. With suitable choice of R, the Montgomery reduction can be efficiently computed.

Advantageously, the present invention is not restricted to the Montgomery reduction but the present invention can also be adapted to other reduction principles.

The present invention is applicable both for GF(p) and for GF(2ⁿ). In this context, an architecture is said to be unified if this architecture is able to work with operands in both prime (p) extension fields and binary (2ⁿ) extension fields:

If p is a prime, the integers modulo p form a field with p elements, denoted by GF(p). A finite field is a field with a finite field order, i.e. a finite number of elements, also called a G[alois]F[ield] or an GF. The order of a finite field is always a prime or a power of a prime. For each prime power, there exists exactly one (with the usual caveat that “exactly one” means “exactly one up to an isomorphism”) finite field GF( ). GF(p) is called the prime field of order p, and is the field of residue classes modulo p

When n>1, GF( ) can be represented as the field of equivalence classes of polynomials whose coefficients belong to GF(p). Any irreducible polynomial of degree n yields the same field up to an isomorphism.

The present invention further relates to a data processing device, in particular to an embedded system, for example to a chip card or to a smart card, comprising at least one integrated circuit carrying out calculations, in particular cryptographic operations, wherein the integrated circuit is protected
against at least one attack, in particular against at least one E[lectro]M[agnetic] radiation attack, or
against at least one crypto-analysis, in particular against at least one D[ifferential]P[ower]A[nalysis]

by blinding all intermediate results of the calculations by at least one random variable.

The present invention finally relates to the use of at least one arrangement as described above and/or of the method as described above in at least one data processing device as described above to be protected against D[ifferential]P[ower]A[nalysis].

As already discussed above, there are several options to embody as well as to improve the teaching of the present invention in an advantageous manner To this aim, reference is made to the claims respectively dependent on claim 1 and on claim 7; further improvements, features and advantages of the present invention are explained below in more detail with reference to a preferred embodiment by way of example and to the accompanying drawings where

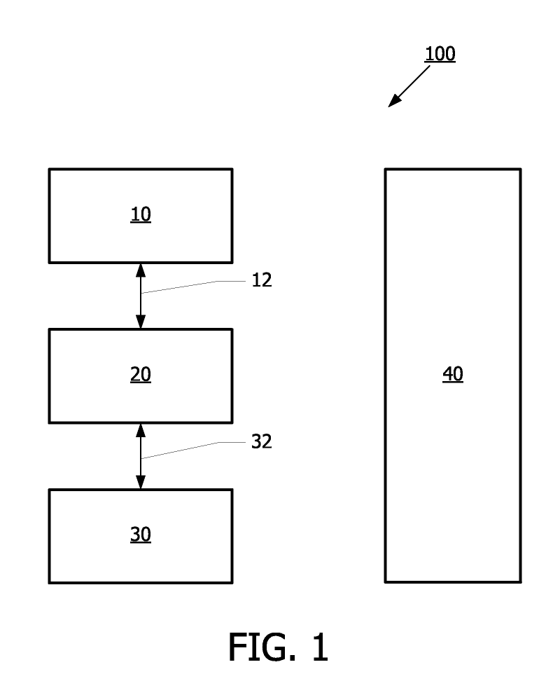

FIG. 1 schematically shows an embodiment of an arrangement according to the present invention working in compliance with the method of the present invention.

The embodiment of a data processing device, namely an embedded system in the form of a chip card or of a smart card comprising an I[ntegrated]C[ircuit] carrying out cryptographic operations refers to a P[ublic]K[ey]I[nfrastructure] system and works according to the method of the present invention, i.e. is protected by a protection arrangement 100 (cf. FIG. 1) from abuse and/or from manipulation.

Basically, it is assumed that the variables X and Y are blinded by X=X/v′ mod(N) and Y=Y/v′ mod(N); in this context, the underlining indicates that the variable is blinded.

Then, the product of X·Y is calculated as follows: R=X·Y·v′ mod(N). R is blinded in the same way as X and Y, and R can therefore be used in the next operation. Instead of multiplying by v′, it is multiplied by v=v′·B with B=2ⁿ, i.e. with B being a power of 2 in order to compensate for the subsequent division by B, caused by the Montgomery reduction.

However, in order to keep the blinding correction as simple as possible, v is desired to be one single word. Therefore, instead of choosing v′, v is chosen as a random single word with v′=v/B mod(N). In order to reduce the chance of an additional reduction, some M[ost]S[ignificant]B[it]s of v can be chosen as zero, making the product R·v the same number of bits smaller.

The present invention requires the ability to calculate the inversion of an operand.

The cryptographic calculations of the integrated circuit can be based on the R[ivest-]S[hamir-]A[dleman] algorithm (cf. prior art document U.S. Pat. No. 4,405,829 or prior art article “A Method for Obtaining Digital Signatures and Public-Key Cryptosystems” by Ron Rivest, Adi Shamir, and Len Adleman in Communications of the ACM, 21 (2), pages 120 to 126, February 1978) calculating for encryption C=M^{e} mod(N) wherein
M is the message to be encrypted,
N=p·q,
e is coprime to (p−1)(q−1),
d is such that x^{ed} mod [(p−1)(q−1)]=1;

the decryption calculates M=C^{d} mod(N).

One of the ways to calculate M^{e} (or C^{d}) is the following:
first step: starting with R=1;
second step: scanning the exponent e from left to right:
third step: always calculating R=R² mod(N);
fourth step: when the scanned bit of e=1, moreover R=R.M mod(N) is calculated.

Thus, the calculation comprises a number of squarings and multiplications.

It is assumed that the modulus N and all operands comprise a number of words m of n bits. After the modular reduction, the variables comprise also of m words of n bits, although the M[ost]S[ignificant]W[ord] might have a few bits more. Before the modular reduction, the result will have more words, usually 1 or m.

The first stage of initial blinding calculates M=M·v′⁻¹=M·B·v⁻¹ mod(N). Although v is one single word, the modular multiplication of M by B·v⁻¹ changes all words of M completely. Only the initial blinding requires an inversion operation.

In the second stage of blinding the multiplication X·Y, it is first calculated as in the unblinded case [symbol] =X·Y mod(N). Next, R= [symbol] ·v mod(N) is calculated. In this context, it should be noted that [symbol] is blinded too but not in the prescribed way. This requires a multiplication of the complete [symbol] by one word of v as well as a subsequent Montgomery reduction.

In this context, it should be noted that it is possible but not such efficient to calculate X=X·v first because this would unblind one of the operands. When X and Y comprise n words, then the multiplication and reduction of X·Y costs 2n²+n multiplications. The blinding correction operation costs 2n+1 multiplications additionally. For 1024 bit RSA for example with n=16 words of 64 bit, this costs about additional six percent of operation power.

In the third stage of blinding the squaring X², it is first calculated as in the unblinded case [symbol] =X² mod(N). Next, R= [symbol] ·v mod(N) is calculated. In this context, it should be noted that [symbol] is blinded but not in the prescribed way. This requires a multiplication of the complete [symbol] by one word of v as well as a subsequent Montgomery reduction.

The modular squaring can be performed by 3/2(n²+n) multiplications. The blinding correction operation costs 2n+1 multiplications additionally. For 1024 bit RSA for example with n=16 words of 64 bit, this costs about additional eight percent of operation power.

In the last step of final unblinding, the final result R has to be unblinded when all RSA calculations have been performed. This final unblinding is done by calculating R=R·v mod(N), using the Montgomery reduction.

For E[lliptic]C[urve]C[ryptography] (cf. prior art article “A Reconfigurable System on Chip Implementation for Elliptic Curve Cryptography over GF(2n)” by M. Ernst, M. Jung, F. Madlener, et al., pages 381 to 399), an elliptic curve and a point P on that curve are chosen.

At a first instance A, a random number a is chosen; a·P is calculated and sent as public key to a second instance B. At this second instance B, also a random number b is chosen; b·P is calculated and sent as public key to the first instance A. Then the first instance A calculates K=a·(b·P) and the second instance B calculates K′=b·(a·P). Now K=K′ and this is the common secret of the two instances A and B.

The basic operation is the multiplication of a point P by a scalar a. This is a repeated point addition X=aP=P+P+ . . . +P (a times):
starting with R=P;
scanning the scalar a from left to right:
always calculating R=2R mod(N) (so-called point doubling);
when the scanned bit of a=1, moreover R=R+P mod(N) is calculated (so-called point addition).

The algorithm for the so-called point doubling and the algorithm for the so-called point addition use operations as X·Y±Z mod(N) and X²±Z mod(N) (like the R[ivest-]S[hamir-]A[dleman] algorithm but also a third operand Z is added or subtracted).

These operations are blinded in the same way as for the R[ivest-]S[hamir-]A[dleman] algorithm.

The point doubling algorithm and the point addition algorithm require also an inversion operation calculating X⁻¹ with X·X⁻¹ mod(N)=1.

The blinding correction (, i.e. the multiplication of the result) can only be applied for the multiplication or squaring but not for the addition or subtraction. Therefore, first X·Y mod(N) or X² mod(N) is calculated.

In the first stage of initial blinding, both the X coordinate as well as the Y coordinate of the point P have to be blinded first. The initial blinding is done in the same way as described above for the R[ivest-]S[hamir-]A[dleman] algorithm.

In the second stage of multiplication (R=X·Y±Z) and squaring (R=X²±Z), first, the product [symbol] =X·Y mod(N) or the squaring [symbol] =X² mod(N) is calculated. Next, R= [symbol] ·v±B·Z mod(N) is calculated. In this context, it should be noted that for 192 bit ECC with m=3 and n=64, the unblinded multiplication takes 21 multiplications, and the blinded multiplication takes 27 multiplications, i.e. 28 percent more; this is both without additional reduction. The unblinded squaring takes 18 multiplications, and the blinded squaring takes 24 multiplications, i.e. 33 percent more.

In the last step of inversion, the unblinded inversion calculates R=X⁻¹ mod(N). The blinded inversion calculates R=(X·v²)⁻¹ mod(N). This can be seen as follows: R=R/v=X⁻¹/v=(X·v)⁻¹·v⁻¹=(X·v²)⁻¹.

It is preferable to calculate first v² and then to multiply v² by X compared to first multiplying X by v and then again by v because this gives an unblinded intermediate result.

The implementation of the present invention may be at least partly on software basis; in this context, processors being suited for R[ivest-]S[hamir-]A[dleman] programming and/or for E[lliptic]C[urve]C[ryptography] programming can also implement the blinding as described above.

An exemplary hardware implementation of the protecting arrangement 100 according to the present invention is shown in FIG. 1 and comprises the ability of performing
multiplications of the type X·Y+R+C with the implementation of the multiplier 10 being known as such, as well as
inversions of the type X⁻¹ mod(N) with the implementation of the inversion algorithm being known as such.

The multiplier 10 and the inverter 30 are respectively connected (=reference numerals 12 and 32 in FIG. 1) to a memory 20 in which all operands are stored. Also the result is stored in this memory 20.

Furthermore, there is a state machine 40
controlling the multiplier 10 for performing the required type of calculation,
controlling the inverter 30 for the inversion operation,
reading the input operands from the memory 20, and
writing of the result to the memory 20.

### LIST OF REFERENCE NUMERALS

100 arrangement
10 multiplier unit of arrangement 100
12 connection between multiplier unit 10 and memory unit 20
20 memory unit of arrangement 100
30 inverter unit of arrangement 100
32 connection between inverter unit 30 and memory unit 20
40 state machine of arrangement 100

1. An arrangement (100) for protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations, characterized by blinding all intermediate results of the calculations by at least one random variable.

2. The arrangement according to claim 1, characterized in that the random variable
is kept constant during a complete calculation, and
is changed when a new calculation is started.

3. The arrangement according to claim 1, characterized in that the calculations are based on the R[ivest-]S[hamir-]A[dleman] algorithm and/or on the E[lliptic]C[urve]C[ryptography] algorithm.

4. The arrangement according to claim 1, characterized by using the Montgomery reduction or another type of reduction.

5. The arrangement according to claim 1, characterized by
at least one memory unit (20) for storing the, in particular all, operands and the, in particular all, results of the calculations;
at least one multiplier unit (10) being connected (12) to the memory unit (20),
at least one inverter unit (30) being connected (32) to the memory unit (20),
at least one state machine (40)
for controlling the multiplier unit (10) for performing the required type of calculation,
for controlling the inverter unit (30) for the inversion operation,
for reading the input operands from the memory unit (20), and/or
for writing the, in particular all, results of the calculations to the memory unit (20).

6. A data processing device, in particular an embedded system, for example a chip card or a smart card, comprising at least one integrated circuit carrying out calculations, in particular cryptographic operations, characterized by at least one arrangement (100) according to claim 1.

7. A method of protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations, characterized by blinding all intermediate results of the calculations by at least one random variable.

8. The method according to claim 7, characterized in that the random variable
is kept constant during a complete calculation, and
is changed when a new calculation is started.

9. The method according to claim 7, characterized in that the calculations are based on the R[ivest-]S[hamir-]A[dleman] algorithm and/or on the E[lliptic]C[urve]C[ryptography] algorithm.

10. The method according to claim 7, characterized by using the Montgomery reduction or another type of reduction.

11. Use of at least one arrangement (100) for protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations, characterized by blinding all intermediate results of the calculations by at least one random variable and/or of the method of protecting at least one data processing device, in particular at least one embedded system, for example at least one chip card or smart card, against at least one attack, in particular against at least one side-channel attack, for example against at least one current trace analysis, the data processing device, in particular at least one integrated circuit of the data processing device, carrying out calculations, in particular cryptographic operations, characterized by blinding all intermediate results of the calculations by at least one random variable in at least one data processing device according to claim 6 to be protected against D[ifferential]P[ower]A[nalysis].
